(19) United States
(12) Patent Application Publication
(10) Pub. No.: US 2025/0289698 A1
(43) Pub. Date: Sep. 18, 2025

(54) CLOSURE HEAD FOR CLOSING CONTAINERS

(71) Applicant: KRONES AG, Neutraubling (DE)

(72) Inventors: Klaus BUCHHAUSER, Deuerling (DE); Sebastian KLEPATZ, Zeitlarn (DE); Markus SCHOENFELDER, Regensburg (DE)

(21) Appl. No.: 19/082,927

(22) Filed: Mar. 18, 2025

(30) Foreign Application Priority Data
Mar. 18, 2024 (DE) 10 2024 107 559.7

(51) Int. Cl. B67B 3/20

(52) U.S. Cl. CPC B67B 3/2066

(57) ABSTRACT

The invention relates, inter alia, to a closure head having a magnetic coupling and an adjusting device having a holding component, an adjusting component, a connecting component and a locking component. The adjusting component carries a first magnetic ring of the magnetic coupling. The connecting component holds the adjusting component adjustably on the holding component for adjusting the first magnetic ring relative to a second magnetic ring of the magnetic coupling for adapting a maximum closing torque. The connecting component is elastically pretensioned for assuming a holding position, in which the connecting component connects the adjusting component to the holding component in a rotationally fixed manner. The locking component is elastically pretensioned for assuming a locked position, in which the locking component blocks the connecting component in the holding position.

### CROSS-REFERENCE TO RELATED APPLICATIONS

This application claims the benefit under 35 U.S.C. § 119(a) of German Patent Application No. DE 10 2024 107 559.7, filed Mar. 18, 2024, entitled CLOSURE HEAD FOR CLOSING CONTAINERS, and whose entire disclosure is incorporated by reference herein.

### TECHNICAL FIELD

The invention relates to a closure head for a closure apparatus for closing a container. The invention also relates to a method for adjusting a magnetic clutch of a closure head.

### TECHNICAL BACKGROUND

In beverage bottling plants, it is known to provide closure apparatuses configured for closing containers with a screw cap, which can also be referred to as cappers or screw cappers. Such apparatuses for closing a container having a screw cap can have a closure head having a closure element, in which a screw cap to be screwed onto a container for closing the container can be received. The closure head can be set into rotation about an axis of rotation and lowered vertically onto the container to be closed, so that the screw cap comes into contact with the container mouth. By rotating the closure head, the screwing on of the screw cap is carried out.

One type of closure head comprises a magnetic coupling that provides a rotational coupling of a drive element of the apparatus, which provides the torque or rotation, and the closure element. Such magnetic clutches can be based on the hysteresis clutch principle. Here, a plurality of magnetic elements, which are connected to the drive element in a rotationally fixed manner, can be positioned opposite a plurality of magnetic elements, which are connected to the closure element in a rotationally fixed manner.

For example, EP 1 387 812 A1 discloses an apparatus for screwing a screw cap onto a container. The apparatus has a magnetic coupling arranged between a drivable spindle and the closure head. An inductive detector that detects the state of movement of the permanent magnets connected to the closure head is provided in the circulation region.

The invention is based on the object of providing an improved adjustment of a magnetic coupling of a closure head for adapting a maximum closing torque.

### SUMMARY OF THE INVENTION

The object is achieved by the features of the independent claims. Advantageous developments are specified in the dependent claims and the description.

One aspect of the present disclosure relates to a (e.g., screw) closure head for a (e.g., rotary) closure apparatus for closing containers. The closure head has a magnetic coupling having a first, preferably outer, magnetic ring (hysteresis ring) and a second, preferably inner, magnetic ring, which interact magnetically with one another for transmitting a torque. The closure head has an adjusting device with a (e.g., driven) holding component, an adjusting component, a connecting component and a locking component. The adjusting component carries the first magnetic ring (e.g., with a rotationally fixed connection between the adjusting component and the first magnetic ring). The connecting component holds the adjusting component adjustably (e.g., in height) on the holding component for adjusting the first magnetic ring relative to the second magnetic ring for adapting a maximum closing torque. The connecting component is elastically pretensioned for assuming a holding position, in which the connecting component connects the adjusting component to the holding component in a rotationally fixed manner. The locking component is elastically pretensioned for assuming a locked position, in which the locking component blocks the connecting component in the holding position.

Advantageously, the adjusting device can considerably simplify the adjustment of the closing torque, which is typically time-consuming and cumbersome to adjust. The closing torque can be adjusted without tools. As a result, adjusting the closing torque during product changeovers can be easily accomplished. For example, it is not necessary to loosen a screw element by a tool and tighten it again after adjustment, as is typically the case. Conventional technology is very complex and prone to errors, in particular in the case of closure apparatuses having many closure heads. If the screw element is not tightened as specified, damage may occur to the ball bearing inside, for example. In addition, there is no need to tip the machine to reach the screw elements, which is advantageous since this process is very error prone (one or more closing heads can easily be forgotten).

In one exemplary embodiment, the connecting component is a spring-loaded pressure piece. Optionally, the connecting component can be supported in a spring-loaded manner on the locking component, preferably on the inside of the locking component. Advantageously, the spring-loaded pressure piece can make a finely stepped adjustment of the closing torque possible.

In a further exemplary embodiment, the connecting component has a first, preferably inner, pin, which abuts (e.g., internally) against the locking component, and a second, preferably outer, pin, which abuts (e.g., externally) against the holding component (e.g., in a groove track of the holding component) and is preferably arranged coaxially with the first pin. Optionally, the connecting component can have an elastic element, preferably a helical compression spring, which elastically supports the second pin on the first pin and is preferably arranged coaxially to the first pin and the second pin. Preferably, the elastic element can elastically pretension the connecting component (e.g., its second pin) for assuming the holding position. Advantageously, this can make possible a structure of the connecting component that provides, on the one hand, a secure and reliable locking and, on the other hand, a finely stepped adjustment of the closing torque.

In one embodiment, the locking component has a groove in which the first pin is guided. Alternatively or additionally, the locking component has a recess for receiving the second pin in portions outside the locked position of the locking component for releasing the connecting component. Advantageously, this allows the connecting component to be securely guided and held in position, on the one hand, and reliably and easily locked and unlocked, on the other hand.

In a further embodiment, the closing head has a stop element that is arranged for limiting the movability (e.g., at the locked position and/or an unlocked position) of the locking component, preferably in a manner fastened to the adjusting component and/or engaging in an elongated hole of the locking component. Advantageously, this simplifies the operation of the adjusting device and prevents incorrect conditions.

In one embodiment variant, the closure head has at least one spacer that keeps the adjusting component and the holding component at a distance for creating a, preferably annular, cleaning gap between the adjusting component and the holding component. Advantageously, this can improve the cleanability of the adjusting device.

In a further embodiment variant, the closing head has a helical spring that elastically supports the locking component on a, preferably peripheral, collar portion on the first magnetic ring for assuming the locked position and preferably coaxially surrounds the first magnetic ring. Advantageously, this can make possible a reliable and space-saving elastic pretensioning of the locking component.

In one exemplary embodiment, the locking component has at least one cleaning opening, via which the adjusting component, the holding component and/or a, preferably annular, cleaning gap between the adjusting component and the holding component is accessible from the outside for feeding cleaning fluid. Alternatively or additionally, the adjusting component has at least one cleaning opening, via which the holding component and/or a, preferably annular, cleaning gap between the adjusting component and the holding component is accessible from the outside for feeding cleaning fluid. Advantageously, this can make possible a thorough cleaning of the closing head without the need to remove and, if applicable, disassemble the closing head.

In a further exemplary embodiment, magnets of the first magnetic ring are encapsulated and/or magnets of the second magnetic ring are encapsulated. Alternatively or additionally, a sleeve-shaped (e.g., thin-walled) metal sheet, preferably stainless steel sheet, covers magnets of the first magnetic ring on an inner peripheral side of the magnets, and/or a (e.g., further) sleeve-shaped (e.g., thin-walled) metal sheet, preferably stainless steel sheet, covers magnets of the second magnetic ring on an outer peripheral side of the magnets. Advantageously, this can achieve a protected arrangement of the magnets, so that they cannot be affected by cleaning fluid, for example.

In one embodiment, the first magnetic ring can be adjusted by the adjusting device for increasing an overlap with the second magnetic ring for increasing the maximum closing torque in a downward direction and/or towards a closure element of the closure head. Advantageously, this can achieve that, unlike conventional methods, an unwanted covering of a closure element by a magnetic ring (hysteresis ring) does not occur when a low closing torque is set. As a result, an advantage may arise when using a gripping head, which finds more space and can therefore be realized significantly shorter. By reversing the adjustment direction, the adjustment travel can also be increased, which results in a larger torque range. It is also possible that both magnetic rings completely overlap at the maximum setting, which was not possible in the past.

In a further embodiment, the connecting component is mounted in the adjusting component so that it can move axially. Alternatively or additionally, the connecting component can be movable in a radial direction with respect to a longitudinal central axis of the closure head from the holding position for adjusting the adjusting component and the first magnetic ring to the holding component, preferably can be pressed out by the holding component, if the locking component does not block the connecting component in the holding position. Advantageously, this allows the first magnetic ring to be rotated step-by-step with fine increments, and the closing torque to be changed.

In one embodiment variant, the locking component is movable parallel to or rotatable about a longitudinal central axis of the closure head between the locked position and an unlocked position, in which the connecting component is released for leaving the holding position. Advantageously, this allows for a simple unlocking and locking of the connecting component, and thus the adjusting component and the first magnetic ring, without tools.

In one embodiment variant, the adjusting component can be rotated, preferably helically, about the holding component in the unlocked position of the locking component, wherein when the adjusting component is rotated, the connecting component is pressed out of the holding position by the holding component against its elastic pretension. Alternatively or additionally, an outer peripheral surface of the holding component has a, preferably helical, groove track, in which the connecting component engages. Optionally, a groove bottom of the groove track can have a plurality of, preferably rounded, recesses arranged one behind the other in series along a longitudinal course of the groove track, for engaging the connecting component in the holding position. Advantageously, this can make possible the step-by-step adaptation of the closing torque with fine increments.

In one exemplary embodiment, the locking component, the adjusting component and/or the holding component are arranged coaxially to one another (and, e.g., to a longitudinal central axis of the closure head). Alternatively or additionally, the locking component, the adjusting component and/or the holding component is sleeve shaped. Alternatively or additionally, the connecting component is pin shaped.

In a further exemplary embodiment, the closure head further has at least one of:
a drive element, preferably a drive shaft, which is connected to the holding component in a driving manner;
a pivot bearing, which rotatably connects the holding component and the second magnetic ring; and
a closure element, preferably a closure cone, which is carried on the second magnetic ring.

A further aspect of the present disclosure relates to a method for adjusting a magnetic coupling of a closure head, as disclosed herein. The method comprises a manual movement (e.g., downwards) of the locking component against its elastic pretension from the locked position into an unlocked position for releasing the connecting component for movement and thus the adjusting component for rotation. The method further comprises a (e.g., step-by-step) manual, preferably helical, rotation of the adjusting component about the holding component for adjusting the first magnetic ring relative to the second magnetic ring up to a desired adjusting position. When the adjusting component is rotated manually, the released connecting component is pressed out of the holding position by the holding component against its elastic pretension. The released connecting component moves back to the holding position in the desired adjusting position under the elastic pretension. The method also comprises a movement of the locking component back into the locked position, so that the connecting component is locked in the holding position again. Advantageously, the method can achieve the same advantages as already described with reference to the closure head.

A further aspect of the present disclosure relates to a container treatment plant (e.g., for controlling the temperature, producing, cleaning, coating, testing, filling, closing, pasteurizing, labeling, printing, marking, laser marking, and/or packaging containers for liquid or pasty media, preferably beverages, liquid foods or products from the pharmaceutical or healthcare industry). The container treatment plant can have an (e.g., rotary) closure apparatus having at least one closure head as disclosed herein.

For example, the containers can be realized as bottles, cans, canisters, cartons, vials, tubes, etc.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a perspective view of a section of a closure head according to an exemplary embodiment of the present disclosure;

FIG. 2 shows a sectional view of a portion of the exemplary closure head; and

FIG. 3 shows a perspective view of a detail of the cross-section of FIG. 2.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

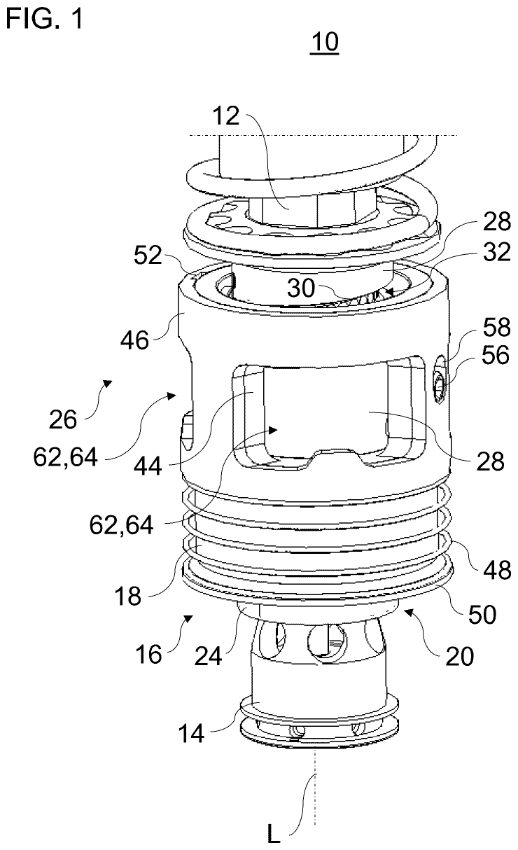

FIG. 1 shows a closure head 10 for a closure apparatus for closing containers. Preferably, the closure head 10 can close a container having a screw cap.

The closure apparatus can have a closure head 10 or preferably a plurality of closure heads 10 for the simultaneous or temporally overlapping closing of a plurality of containers. The closure apparatus can be a rotary closure apparatus, for example. The closure heads 10 can be arranged distributed about the periphery of a capper carousel of the closure apparatus. Alternatively, the closure apparatus can, for example, be a linear closure apparatus, e.g. with a plurality of closure heads 10 arranged in series next to or behind one another.

For example, the closure apparatus can be comprised in a container handling plant. The closure apparatus can be arranged downstream of or integrated with a filling apparatus for filling the containers with a liquid or pasty filling material.

In the following, the closure head 10 is described in more detail by way of example with reference to FIGS. 1 to 3.

The closure head 10 has a magnetic coupling 16 and an adjusting device 26. Preferably, the closure head 10 can also have, for example, a drive element 12 and a closure element 14 (only shown in FIG. 1).

The drive element 12 can be driven in any suitable way, e.g. by an electric drive unit. The drive element 12 can have a vertical axis of rotation. The drive element 12 can preferably be a shaft, preferably a hollow shaft.

The drive element 12 can be connected to the magnetic coupling 16 for transmitting a drive torque to the closure element 14. Specifically, the drive element 12 can be connected to a drive side of the magnetic coupling 16. For example, the drive element 12 can be connected to the magnetic coupling 16 in a driving manner via the adjusting device 26.

The closure element 14 can have a closure receptacle. A screw cap held in the closure receptacle can be screwed onto a container when the closure element 14 is rotated.

The closure element 14 is preferably realized as a, preferably toothed, closure cone. For example, an elastic holding ring for holding a screw cap can be arranged at the lower end of the closure element 14.

The closure element 14 can receive a drive torque from the magnetic coupling 16. The closure element 14 can be connected to an output side of the magnetic coupling 16. The closure element 14 can, for example, be carried on the output side of the magnetic coupling 16.

The magnetic coupling 16 can also be referred to as a hysteresis coupling. The magnetic coupling 16 has a first magnetic ring 18 and a second magnetic ring 20.

The first magnetic ring 18 can be an outer magnetic ring, and the second magnetic ring 20 can be an inner magnetic ring. The first magnetic ring 18 can be arranged on the outside of the second magnetic ring 20 or surround the second magnetic ring 20. The magnetic rings 18, 20 can be arranged coaxially to a longitudinal central axis L of the closure head 10. The magnetic rings 18, 20 can be spaced apart from one another by an air gap. The magnetic rings 18 and 20 can be mounted so that they can rotate relative to one another.

The first magnetic ring 18 and the second magnetic ring 20 interact magnetically with one another for transmitting a torque. The transmitted torque can be used to drive the closure element 14 for screwing a screw cap onto a container. The closure element 14 can be carried, preferably on the inside, on the second magnetic ring 20.

The magnetic rings 18, 20 can in each case have a plurality of permanent magnets, which are arranged in a peripheral direction about the longitudinal central axis L. The permanent magnets can be oriented upright, for example.

The magnets of the first magnetic ring 18 are preferably encapsulated. The magnets can be completely enclosed by a housing of the first magnetic ring 18. The housing can preferably have a sleeve-shaped metal sheet 22. The metal sheet 22 can preferably be a stainless steel sheet. The metal sheet 22 can cover the magnets of the first magnetic ring 18 on an inner peripheral side of the magnets. The inner peripheral side can be directed towards the second magnetic ring 20.

Alternatively or additionally, the magnets of the second magnetic ring 20 can be encapsulated. The magnets can be completely enclosed by a housing of the second magnetic ring 20. The housing can preferably have a sleeve-shaped metal sheet 24. The metal sheet 24 can preferably be a stainless steel sheet. The metal sheet 24 can cover the magnets of the second magnetic ring 20 on an outer peripheral side of the magnets. The outer peripheral side can be directed towards the first magnetic ring 18.

The first magnetic ring 18 can be connected to the drive element 12 in a rotationally fixed manner. The second magnetic ring 20 can be connected to the closure element 14 in a rotationally fixed manner.

Below a maximum closing torque (breakaway torque) that can be predefined by a relative arrangement between the first and second magnetic rings 18, 20, a transmission of torque can be carried out from the drive element 12 via the magnetic coupling 16 to the closure element 14 due to the magnetic force generated between the magnetic rings 18, 20. If the maximum closing torque is reached or exceeded, the magnetic holding force between the magnetic rings 18 and 20 and thus between the drive element 12 and the closure element 14 breaks off. The closure element 14 can slide substantially evenly relative to the drive element 12. This ensures, for example, that a screw cap is screwed onto the container with a predefined maximum closing torque.

The adjusting device 26 can adapt a relative arrangement between the first magnetic ring 18 and the second magnetic ring 20. With the adjusting device 26, a relative arrangement between the first and second magnetic ring 18, 20 can be changed for adapting the maximum closing torque. The relative arrangement can refer to an axial overlap of the magnetic rings 18, 20 with respect to the longitudinal central axis L or an overlap (concealment) of the magnetic rings 18, 20 in a radial viewing direction with respect to the longitudinal central axis L.

Preferably, the adjusting device 26 allows the first magnetic ring 18 to be adjustable downward towards the closure element 14 for increasing the overlap with the second magnetic ring 20 and thereby increasing the maximum closing torque. On the other hand, the adjusting device 26 can allow the first magnetic ring 18 to be adjustable in an upward direction away from the closure element 14 for reducing an overlap with the second magnetic ring 20 for reducing the maximum closure torque.

The adjusting device 26 has a holding component 28, a connecting component 36, an adjusting component 44 and a locking component 46.

Preferably, the holding component 28, the adjusting component 44 and the locking component 46 are arranged coaxially to one another and to the longitudinal central axis L. Preferably, the holding component 28, the adjusting component 44 and/or the locking component 46 can in each case be sleeve shaped. Preferably, the connecting component 36 is pin shaped.

The holding component 28 can be connected to the drive element 12 in a rotationally fixed manner. For example, the holding component 28 can be connected to the drive element 12 in a force-fitting and/or form-fitting manner. It is also possible that the holding component 28 and the drive element 12 can be integrally connected to one another.

An outer peripheral surface of the holding component 28 can have a groove track 30. The groove track 30 preferably runs helically about the longitudinal central axis L. A groove bottom of the groove track 30 can have a plurality of recesses 32 along a longitudinal course of the groove track 30. The recesses 32 are preferably realized as rounded depressions, e.g. in the form of spherical segments. The recesses 32 can be arranged one behind the other in series along the longitudinal course of the groove track 30.

The holding component 28 can carry the first magnetic ring 18. Specifically, the holding component 28 can carry the first magnetic ring 18 via the connecting component 36 and the adjusting component 44.

The holding component 28 can carry the second magnetic ring 20. Specifically, the holding component 28 can carry the second magnetic ring 20 via a pivot bearing 34. The pivot bearing 34 can rotatably connect the holding component 28 and the second magnetic ring 20. The pivot bearing 34 can be arranged inside the holding component 28. The pivot bearing 34 can, for example, be a ball bearing, preferably an angular contact ball bearing.

The holding component 28 can carry the closure element 14. Specifically, the holding component 28 can carry the closure element 14 via the pivot bearing 34 and the second magnetic ring 20.

The connecting component 36 holds the adjusting component 44 adjustably on the holding component 28 for adjusting the first magnetic ring 18 relative to the second magnetic ring 20 for adapting the maximum closing torque.

Preferably, the connecting component 36 is a spring-loaded pressure piece. For example, the connecting component 36 can have a first pin 38, a second pin 40 and a spring-loaded element 42.

The connecting component 36 can preferably be oriented perpendicularly to the longitudinal central axis L. For example, the pins 38, 40 can be oriented perpendicularly to the longitudinal central axis L.

Preferably, the pins 38, 40 and optionally the elastic element 42 are arranged coaxially to one another. The pins 38 and 40 can be movable relative to one another.

Preferably, the first pin 38 can be an inner pin. The second pin 40 can preferably be an outer pin. For example, the first pin 38 and/or the elastic element 42 can be received in a hole, preferably blind hole, of the second pin 40. Preferably, the elastic element 42 is arranged between the first pin 38 and the second pin 40. For example, the elastic element 42 can surround the first pin 38. The elastic element 42 is preferably a helical compression spring.

The connecting component 36 can be mounted to be axially movable (displaceable) within the adjusting component 44. Preferably, the connecting component 36 can be movable in a radial direction with respect to the longitudinal central axis L.

The adjusting component 44 can, for example, have a through hole in which the connecting component 36 is mounted so that it can move axially. It is possible, for example, that a sliding bush is arranged in the through hole. The connecting component 36 can extend through this sliding bush. Specifically, the second pin 40 can preferably be mounted so that it can move axially in the adjusting component 44, preferably in the sliding bush of the adjusting component 44.

The connecting component 36 can abut against the locking component 46 and the holding component 28 at opposite ends. For example, an end (a head) of the first pin 38 can bear against an inner peripheral side of the locking component 46. For example, the second pin 40 can bear against the holding component 28. Preferably, one end region of the second pin 40 protrudes into the groove track 30.

In a holding position of the connecting component 36, the connecting component 36 connects the adjusting component 44 to the holding component 28 in a rotationally fixed manner. In the holding position, the connecting component 36 can engage in one of the recesses 32 of the grooved track 30. Preferably, a front end of an end region of the second pin 40 can engage in one of the recesses 32 of the groove track 30 if the connecting component 36 is in the holding position.

The connecting component 36 is elastically pretensioned for assuming a holding position. For example, the elastic element 42 can elastically support the second pin 40 on the first pin 38. Preferably, the elastic element 42 can press the second pin 40 into the groove track 30.

Preferably, the connecting component 36 can be supported on the locking component 46 in a spring-loaded manner, preferably on the inside of the locking component. Specifically, for example, the elastic element 42 can be supported on the first pin 38, which in turn can be supported on an inner peripheral side of the locking component 46.

The adjusting component 44 carries the first magnetic ring 18. For example, the adjusting component 44 can carry the first magnetic ring 18 at a lower end of the adjusting component 44. The adjusting component 44 and the first magnetic ring 18 can be connected to one another in a rotationally fixed manner.

For example, the adjusting component 44 and the first magnetic ring 18 can be integrally connected to one another. It is also possible that the adjusting component 44 and the first magnetic ring 18 are fastened to one another, for example in a form-fitting or force-fitting manner.

Preferably, the adjusting component 44 can be arranged on the outside of the holding component 28 and/or on the inside of the locking component 46.

By adjusting the adjusting component 44 relative to the holding component 28, the first magnetic ring 18 can be adjusted relative to the second magnetic ring 20. Preferably, a height adjustment of the first adjusting component 44 relative to the holding component 28 can cause a height adjustment of the first magnetic ring 18 relative to the second magnetic ring 20.

Specifically, provided that the connecting component 36 is not blocked in the holding position, the adjusting component 44 can be rotatable about the holding component 28, preferably helically. The, preferably helical, rotation can be guided by the connecting component 36 guided in the groove track 30. When the adjusting component 36 is rotated, the (unlocked) connecting component 36 can be pressed out of the holding position from the holding component 28 against its elastic pretension by the elastic element 42. Due to the helical rotation of the adjusting component 44 about the holding component 28, a height adjustment of the adjusting component 44 relative to the holding component 28 preferably results. This can result in a relative height adjustment of the first magnetic ring 18 to the second magnetic ring 20, as a result of which the maximum closing torque can be adapted.

For example, a clockwise, preferably helical, rotation of the adjusting component 44 about the holding component 28 can result in a lowering of the adjusting component 44 relative to the holding component 28, and a counterclockwise, preferably helical, rotation of the adjusting component 44 about the holding component 28 can result in a raising of the adjusting component 44 relative to the holding component 28 (or vice versa).

Preferably, a lowering of the adjusting component 44 relative to the holding component 28 can lead to a lowering of the first magnetic ring 18 relative to the second magnetic ring 20, as a result of which preferably an overlap of the first and second magnetic rings 18 and 20 can be increased. On the other hand, preferably a raising of the adjusting component 44 relative to the holding component 28 can lead to a raising of the first magnetic ring 18 relative to the second magnetic ring 20, as a result of which preferably an overlap of the first and second magnetic rings 18 and 20 can be reduced.

The locking component 46 is elastically pretensioned for assuming a locked position. In the locked position, the locking component 46 blocks the connecting component 36 in the holding position.

Preferably, the locking component 46 can be elastically pretensioned by an elastic element, e.g. a helical spring 48. The helical spring 48 is preferably a helical compression spring.

The helical spring 48 is preferably arranged below the locking component 46. The helical spring 48 can, for example, be arranged coaxially to the longitudinal central axis L and the first magnetic ring 18. Preferably, the helical spring 48 can surround the first magnetic ring 18.

Preferably, the helical spring 48 can be supported on one side at a lower end of the locking component 46. On the other hand, the helical spring 48 can preferably be supported on a collar portion 50. The collar portion 50 is preferably a peripheral collar portion. For example, the collar portion 50 can be arranged on the first magnetic ring 18, for example peripherally and/or at a lower end of the first magnetic ring 18.

Preferably, the locking component 46 can be manually movable parallel to the longitudinal central axis L between the locked position and an unlocked position. In the unlocked position, the locking component 46 can release the connecting component 36 for leaving the holding position. Preferably, the locking component 46 can be moved vertically downwards from the locked position to the unlocked position.

However, it is also possible that the locking component 46 can be moved from the locked position to the unlocked position in another way. For example, the locking component 46 can be rotated from the locked position to the unlocked position.

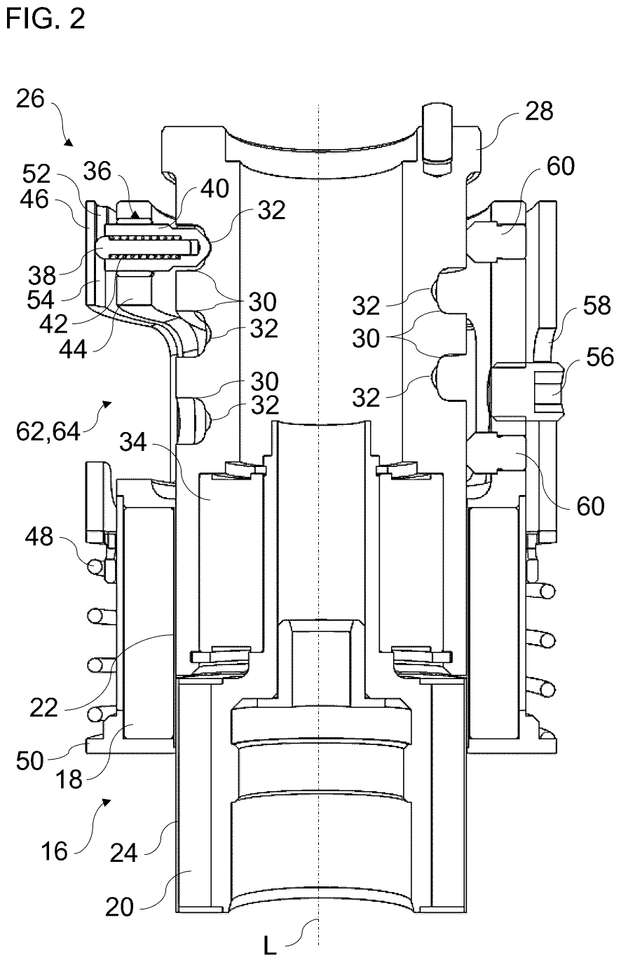

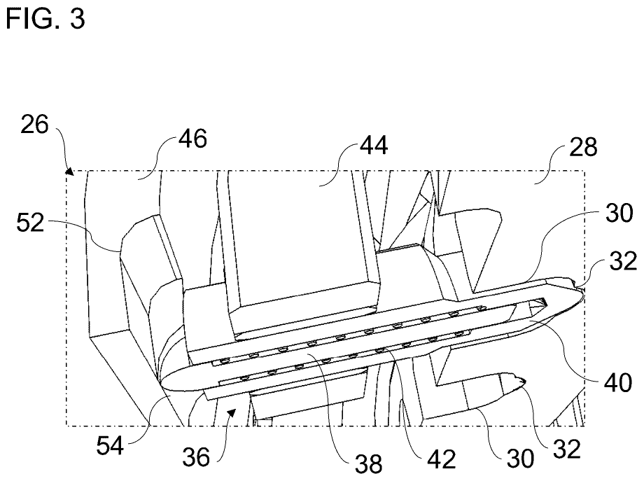

Preferably, the locking component 46 can have a recess 52, as shown by way of example in FIGS. 2 and 3. Preferably, the recess 52 can be realized as a trough-shaped or bowl-shaped depression, for example. The recess 52 is preferably arranged on an inner peripheral side of the locking component 46.

The recess 52 can preferably be arranged and dimensioned such that it can receive the second pin 40 of the connecting component 36 in portions only if the locking component 46 is in the unlocked position. Specifically, in the unlocked position, an end region of the second pin 40 facing the locking component 46 can preferably be received in the recess 52.

For example, the recess 52 can have a depth that is greater than or equal to a depth of the recesses 32. Preferably, the recess 52 can have a width that is greater than or equal to a width of the connecting component 36 and/or the second pin 40. Preferably, the recess 52 can be arranged in an upper half of the locking component 46.

Preferably, the locking component 46 positioned in the unlocked position can release the, preferably helical, rotation of the adjusting component 44, since the connecting component 36 (e.g., its second pin 40) can be pressed out of the holding position and into the recess 52 by the holding component 28 against its elastic pretension when the adjusting component 44 is rotated.

On the other hand, the locking component 46 positioned in the locked position can block the rotation of the adjusting component 44, since the connecting component 36 (e.g., its second pin 40) cannot be pressed out of the holding position into the recess 52 by the holding component 28 against its elastic pretension when the adjusting component 44 is rotated.

Preferably, the locking component 46 can further have a groove 54, as also shown by way of example in FIGS. 2 and 3. Preferably, the groove 54 can be realized as a longitudinal groove. The groove 54 can be preferentially arranged on an inner peripheral side of the locking component 46.

Preferably, the groove 54 can be arranged in a lower half of the locking component 46. For example, the groove 54 can merge into the recess 52.

Preferably, the groove 54 can be oriented vertically. For example, one end (head) of the first pin 38 can be guided in the groove 54.

For example, the groove 54 can have a width that is smaller than the width of the recess 52. Preferably, the groove 54 can have a width that is greater than or equal to a width of the end of the first pin 38. Preferably, the groove 54 can have a depth that corresponds to a depth of the recess 52.

The movability of the locking component 46 between the locked position and the unlocked position can be limited by a stop element 56. The stop element 56 can preferably limit both the locked position and the unlocked position.

For example, the stop element 56 can be pin shaped or screw shaped. The stop element 56 is preferably oriented perpendicularly to the longitudinal central axis L.

The stop element 56 is preferably fastened to the adjusting component 44. For example, the stop element 56 can be fastened, for example screwed in, in a blind or through hole in the adjusting component 44.

Preferably, the stop element 56 engages in an elongated hole 58 of the locking component 46. The elongated hole 58 is preferably oriented vertically. An upper end of the elongated hole 58 can, for example, define the unlocked position of the locking component 46. A lower end of the elongated hole 58 can, for example, define the locked position of the locking component 46.

Preferably, the stop element 56 can also connect the locking component 46 and the adjusting component 44 to one another in a rotationally fixed manner, e.g. by engaging in the elongated hole 58.

Optionally, the adjusting component 44 and the holding component 28 can be spaced apart from one another. Specifically, an inner peripheral side of the adjusting component 44 and an outer peripheral side of the holding component 28 can be spaced apart from one another. Preferably, a (cleaning) gap can be formed between the holding component 28 and the adjusting component 44. The cleaning gap can extend over the entire height of the adjusting component 44 and the holding component 28.

For example, the adjusting device 26 can have at least one spacer 60. The at least one spacer 60 can keep the adjusting component 44 and the holding component 28 at a distance for creating a cleaning gap between them.

The at least one spacer 60 can, for example, be fastened in or on one of the holding component 28 and the adjusting component 44, e.g. screwed in, pressed in or glued in, or integrally connected in one piece and slidingly contact the other of the holding component 28 and the adjusting component 44.

Preferably, a plurality of spacers 60 can be comprised. The plurality of spacers 60 can, for example, be arranged in a manner distributed in a peripheral direction about the longitudinal central axis L and/or spaced apart from one another with respect to the longitudinal central axis L.

Optionally, the adjusting component 44 and/or the locking component 46 can have at least one cleaning opening 62, 64. The at least one cleaning opening 62, 64 can, for example, be arranged below the connecting component 36. Preferably, the cleaning gap between the adjusting component 44 and the holding component 28 can be accessible from the outside via the at least one cleaning opening 62, 64 and can thus be reached with cleaning fluid fed from the outside.

One cleaning opening 62 of the adjusting component 44 and one cleaning opening 64 of the locking component 46 can be aligned with one another, e.g. if the locking component 46 is in the locked position.

The at least one cleaning opening 62, 64 can be rectangular, for example.

The at least one cleaning opening 62, 64 can preferably extend over at least one third or at least one half of a total height of the adjusting component 44 or the locking component 46. The at least one cleaning opening 62, 64 can preferably extend by an angular range of at least 15°, at least 20°, at least 25° or at least 30° in a peripheral direction with respect to the longitudinal central axis L.

Preferably, a plurality of cleaning openings 62 and/or 64 can be comprised. The plurality of cleaning openings 62 and/or 64 can, for example, be arranged in a manner distributed in a peripheral direction about the longitudinal central axis L and/or spaced apart from one another with respect to the longitudinal central axis L.

The method for adjusting the magnetic coupling 16 made possible by the closure head 10 is explained below with reference to FIGS. 1 to 3.

Initially, the locking component 46 can be moved manually from the locked position to the unlocked position. Preferably, the locking component 46 can be displaced, e.g. downwards. As already explained, a manual rotation of the locking component 46 could alternatively be carried out from the locked position to the unlocked position, for example. The manual movement of the locking component 46 is carried out against the elastic pretension of the locking component 46, which is caused, for example, by the helical spring 48. In the unlocked position, the movability of the connecting component 36 and thus the, preferably helical, rotatability of the adjusting component 44 is released.

While the locking component 46 can be held in the unlocked position, the adjusting component 44 can be manually rotated, preferably helically, about the holding component 28 for adjusting the first magnetic ring 18 relative to the second magnetic ring 20 up to a desired adjusting position. Preferably, the locking component 46 can also rotate. When the adjusting component 44 is rotated manually, the released connecting component 36 can be pressed out of the holding position from the holding component 28 against its elastic pretension by the elastic element 42. Specifically, the second pin 40 can preferably be pressed out of a recess 32 and thereby enter/be pressed into the recess 52 at an opposite end of the second pin 40.

In the desired adjusting position (and, if applicable, any intermediate position with its own recess 32 on the way to the adjusting position), the released connecting component 36 can move back into the holding position under the elastic pretension of the elastic element 42. Specifically, the second pin 40 can preferably be pressed out of the recess 52 under the elastic pretension of the elastic element 42, thereby entering/being pressed into the recess 32 at an opposite end of the second pin 40.

In the desired adjusting position, the locking component 36 can then be moved back into the locked position, for example manually and/or by the effect of the elastic pretension, e.g. by the helical spring 48. This allows the connecting component 36 to be locked in the holding position again. This advantageously results in a rotationally fixed connection between the holding component 28, the connecting component 36, the adjusting component 44 and the first magnetic ring 18.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all features of independent claim 1 and, for example, independently of the features relating to the presence and/or configuration of the magnetic coupling, the adjusting device, the holding component, the adjusting component, the connecting component and/or the locking component of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 closure head
12 drive element
14 closure element
16 magnetic coupling
18 first magnetic ring
20 second magnetic ring
22 metal sheet
24 metal sheet
26 adjusting device
28 holding component
30 grooved track
32 recess
34 pivot bearing
36 connecting component
38 pir
40 pin
42 elastic element
44 adjusting component
46 locking component
48 helical spring
50 collar portion
52 recess
54 groove
56 stop element
58 elongated hole
60 spacer
62 cleaning opening
64 cleaning opening
L longitudinal central axis

1. A closure head for a closure apparatus for closing a container, having:
a magnetic coupling having a first magnetic ring and a second magnetic ring, which interact magnetically with one another for transmitting a torque; and
an adjusting device having a holding component, an adjusting component, a connecting component and a locking component, wherein:
the adjusting component carries the first magnetic ring;
the connecting component adjustably holds the adjusting component on the holding component for adjusting the first magnetic ring relative to the second magnetic ring for adapting a maximum closing torque;
the connecting component is elastically pretensioned for assuming a holding position, in which the connecting component connects the adjusting component to the holding component in a rotationally fixed manner; and
the locking component is elastically pretensioned for assuming a locked position, in which the locking component blocks the connecting component in the holding position.

2. The closure head according to claim 1, wherein:
the connecting component is a spring-loaded pressure piece.

3. The closure head according to claim 1, wherein the connecting component has:
a first pin, which abuts against the locking component,
a second pin, which abuts against the holding component; and
an elastic element, which elastically supports the second pin on the first pin.

4. The closure head according to claim 1, wherein the connecting component has at least one of:
a spring-loaded pressure piece supported on an inside of the locking component in a spring-loaded manner; and
a combination of an inner pin that abuts against the locking component, an outer pin that abuts against the holding component and is arranged coaxially to the inner pin, and a helical compression spring that elastically supports the outer pin on the inner pin and is arranged coaxially to both the inner pin and the outer pin.

5. The closure head according to claim 3, wherein the locking component has at least one of:
a groove, in which the first pin is guided; and
a recess for receiving the second pin in portions outside the locked position of the locking component for releasing the connecting component.

6. The closure head according to claim 1, further having at least one of the following:
a stop element, which is arranged for limiting a movability of the locking component;
at least one spacer, which keeps the adjusting component and the holding component at a distance for creating a cleaning gap between the adjusting component and the holding component; and
a helical spring, which elastically supports the locking component on a collar portion on the first magnetic ring for assuming the locked position.

7. The closure head according to claim 6, wherein at least one of:
the stop element is arranged for limiting the movability of the locking component in at least one of a manner fastened to the adjusting component and engaging in an elongated hole of the locking component;
the cleaning gap is an annular cleaning gap;
the collar portion is a peripheral collar portion; and
the helical spring coaxially surrounds the first magnetic ring.

8. The closure head according to claim 1, wherein at least one of:
the locking component has at least one cleaning opening, via which at least one of the adjusting component, the holding component and a cleaning gap between the adjusting component and the holding component is accessible from the outside for feeding cleaning fluid; and
the adjusting component has at least one cleaning opening, via which at least one of the holding component and a cleaning gap between the adjusting component and the holding component is accessible from the outside for feeding cleaning fluid.

9. The closure head according to claim 1, wherein at least one of the following conditions is met:
magnets of the first magnetic ring are encapsulated;
magnets of the second magnetic ring are encapsulated;
a first sleeve-shaped metal sheet covers magnets of the first magnetic ring on an inner peripheral side of the magnets; and
a second sleeve-shaped metal sheet covers magnets of the second magnetic ring on an outer peripheral side of the magnets.

10. The closure head according to claim 1, wherein:
the first magnetic ring is adjustable by the adjusting device for increasing an overlap with the second magnetic ring for at least one of increasing the maximum closing torque in a downward direction and towards a closure element of the closure head.

11. The closure head according to claim 1, wherein at least one of:
the first magnetic ring is an outer magnetic ring;
the second magnetic ring is an inner magnetic ring;
a first sleeve-shaped stainless-steel sheet covers magnets of the first magnetic ring; and
a second sleeve-shaped stainless-steel sheet covers magnets of the second magnetic ring on an outer peripheral side of the magnets.

12. The closure head according to claim 1, wherein at least one of:
the connecting component is mounted in the adjusting component so that it is axially moveable; and
if the locking component does not block the connecting component in the holding position, the connecting component is movable in a radial direction with respect to a longitudinal central axis of the closure head from the holding position for adjusting the adjusting component and the first magnetic ring to the holding component.

13. The closure head according to claim 1, wherein:
the locking component is movable parallel to or rotatable about a longitudinal central axis of the closure head between the locked position and an unlocked position, in which the connecting component is released for leaving the holding position.

14. The closure head according to claim 1, wherein:
the adjusting component is rotatable about the holding component in the unlocked position of the locking component, wherein when the adjusting component is rotated, the connecting component is pressed out of the holding position by the holding component against its elastic pretension.

15. The closure head according to claim 1, wherein at least one of:
the locking component has at least one cleaning opening via which an annular cleaning gap between the adjusting component and the holding component is accessible from the outside for feeding cleaning fluid;
the adjusting component has at least one cleaning opening via which an annular, cleaning gap between the adjusting component and the holding component is accessible from the outside for feeding cleaning fluid;
when the locking component does not block the connecting component in the holding position, the connecting component is pressable out by the holding component; and
the adjusting component is helically rotatable about the holding component in the unlocked position of the locking component.

16. The closure head according to claim 1, wherein:
an outer peripheral surface of the holding component has a groove track, in which the connecting component engages.

17. The closure head according to claim 16, wherein at least one of:
the groove track is helical; and
a groove bottom of the groove track has a plurality of rounded recesses arranged one behind the other in series along a longitudinal course of the groove track for engaging the connecting component in the holding position.

18. The closure head according to claim 1, wherein at least one of the following conditions is met:
at least one of the locking component, the adjusting component and the holding component are arranged coaxially to one another;
at least one of the locking component, the adjusting component and the holding component is sleeve shaped; and
the connecting component is pin shaped.

19. The closure head according to claim 1, further having at least one of the following:
a drive element including a drive shaft, wherein the drive element is connected to the holding component in a driving manner;
a pivot bearing, which rotatably connects the holding component and the second magnetic ring; and
a closure element including a closure cone, wherein the closure element is carried on the second magnetic ring.

20. A method for adjusting a magnetic clutch of the closure head according to claim 1, wherein the method comprises:
manually moving of the locking component against its elastic pretension from the locked position into an unlocked position for releasing the connecting component for movement and thus the adjusting component for rotation;
manually rotating of the adjusting component about the holding component for adjusting the first magnetic ring relative to the second magnetic ring up to a desired adjusting position, wherein:
when the adjusting component is rotated manually, the released connecting component is pressed out of the holding position by the holding component against its elastic pretension; and
the released connecting component in the desired adjusting position moves back to the holding position under the elastic pretension; and
moving back of the locking component into the locked position, so that the connecting component is locked again in the holding position.
